(19) United States
(12) Patent Application Publication
(10) Pub. No.: US 2025/0163736 A1
(43) Pub. Date: May 22, 2025

(54) LATCHBOLT MECHANISM AND LATCHBOLT ACCOMMODATING MECHANISM

(71) Applicant: Incubico Limited, Tortola (VG)

(72) Inventor: Tsui Man LEE, Chai Wan (HK)

(21) Appl. No.: 18/995,965

(22) PCT Filed: Jul. 9, 2018
(86) PCT No.: PCT/CN2018/094941

§ 371 Date: Jan. 17, 2025

(51) Int. Cl. E05C 3/12

(52) U.S. Cl. CPC E05C 3/124

(57) ABSTRACT

The present invention relates to the field of locks and relates to a latchbolt mechanisms, comprising a rotatable latchbolt (16) and an elastic element (17), wherein the rotatable latchbolt (16) is fixedly mounted on a rotatable pin shaft, round which the rotatable latchbolt rotates, and wherein the elastic element (17) holds the rotatable latchbolt (16) in an extended state. Furthermore, the present invention relates to a latchbolt accommodating mechanism, comprising an accommodating chamber (b1) and a cover plate (b2), wherein a chamber opening of the accommodating chamber is covered by the cover plate, and
wherein a first through hole (b21) and a second through hole (b22) are mounted on the cover plate, wherein the stop block (162) is inserted rotatably into the first through hole (b21) and the rotatable latchbolt (16) is inserted rotatably into the second through hole (b22). Therefore, a rotational unlocking and locking is enabled and is suitable not only for hinged doors, but also for sliding doors. By a rotary movement, actions of door opening and closing are avoided in a usual case.

### TECHNICAL FIELD

The present invention relates to the field of locks, particularly, latchbolt mechanisms and latchbolt accommodating mechanisms.

### BACKGROUND ART

Existing latchbolts usually move in a translational manner in that only two movements of stretching inwards and outwards are allowed. The existing latchbolts are only suitable for hinged doors, but not for sliding doors and the majority of the existing doors do not comprise a latchbolt. Rather, an external structure designed as a snap fastener or as a snap hook is provided and the sliding door is shut thereby.

The translational locking mechanisms have the following disadvantages: 1. If external factors, such as wind etc., are applied to the door, it is easy to trigger an incorrect action such as an unintended action by shutting the door; 2. The existing latchbolts can be easily broken, especially with a higher probability of damage if a door is forcibly broken; 3. existing latchbolts have a translationally moving structure. Without the presence of a stop structure or a clamping structure, an unusual unlocking takes place easily after a latchbolt is inserted into a lock opening, which thus disadvantages theft-proof.

### DISCLOSURE OF INVENTION

The object of the invention is to provide a latchbolt mechanism and a latchbolt accommodating mechanism, which can enable a rotational unlocking and locking and are suitable not only for hinged doors, but also for sliding doors. By a rotary movement, actions of door opening and closing are avoided in a usual case.

The object is achieved by the following subject matter of the present invention:

A latchbolt mechanism, comprising a rotatable latchbolt and an elastic element, wherein the rotatable latchbolt is fixedly mounted on a rotatable pin shaft, wherein the rotatable latchbolt rotates around the rotatable pin shaft; wherein the elastic element holds the rotatable latchbolt in an extended state; wherein a rotating movement is used to unlatch and latch and to avoid door opening and closing in an unnatural state.

A jamming block is preferably at one corner of the rotatable latchbolt, wherein the stop block is fixed at the end portion of the rotatable latchbolt, wherein the boundaries between the stop block and each plane of the rotatable latchbolt forms a step structure, and wherein the stop block forms a protruding part in such a way that the stop block is able to be clamped within a latchbolt accommodating mechanism when the rotatable latchbolt is inserted into the latchbolt accommodating mechanism. Thus, the block mechanism is more reliable.

Furthermore, the planes of the stop block, which are not connected to the rotatable latchbolt, have an inclined or curved design, and the plane of the stop block, which is connected to the rotatable latchbolt, forms a front surface. The inclined or curved surfaces have a function as a guide when the stop block is rotatably inserted into the bolt accommodating mechanism.

In the case that the surfaces that are not connected to the rotatable bolt have an inclined design, there are preferably at least three inclined surfaces, wherein two of them are mirror-symmetrical and the other one connects these two mirror-symmetrical surfaces. It is treated equally on both sides of the door.

Furthermore, the rotatable latchbolt has a design as a plate-shaped structure. The plate-shaped structure has a larger width, so that the door is not easily broken into under shear force in the event of a forcible break-in.

The rotatable latchbolt has preferably a semicircular design, so that the rotatable latchbolt has a smaller rotating radius.

Furthermore, a guiding groove is provided in a rotating direction of the rotatable latchbolt, in which a stop protuberance is provided and which is perpendicular to the rotating plane of the rotatable latchbolt. A hook of a cylinder moves into the guiding groove and engages with the stop protuberance when the rotating latchbolt is driven. The rotating latchbolt rotates with the hook.

The stop protuberance also has a round cross section. With this refinement, the frictional force during rotating becomes smaller, which makes rotating easier and the wear-and-tear becomes less.

Furthermore, the present invention relates to a latchbolt accommodating mechanism, comprising an accommodating chamber and a cover plate, wherein a chamber opening of the accommodating chamber is covered by the cover plate.

A first through hole and a second through hole are mounted on the cover plate, wherein the stop block is inserted rotatably into the first through hole and the rotatable latchbolt is inserted rotatably into the second through hole. After the stop block has been inserted into the accommodating chamber in a rotatable manner, it is jammed in the second through hole. Opening the door can only be actuated by turning it in the opposite direction.

Furthermore, opening of the first through hole is rectangular and opening of the second through hole is rectangular, wherein the first through hole and the second through hole form an inversed convex structure.

In comparison with a profile opening, the product according to the present invention are easier to manufacture or to process.

In comparison to the prior art, the present invention provides the following advantages:
1. Actions to open and close are realized by rotating and an unintentional incorrect operation in an unnatural manner is avoided;
2. Due to the arrangement of the stop block, the rotatable latchbolt is stopped after a rotatable entry in the accommodating chamber. An action to open the door may only be triggered by rotating in the opposite direction, such that the latched status is reliable.
3. The plate-shaped rotatable latchbolt has a greater width. Therefore, a greater shear force can be absorbed in the event of a forcible break-in.

### BRIEF DESCRIPTION OF DRAWING

The present invention is further described in conjunction with the non-limiting embodiments given by the figures, in which

FIG. 1 shows a schematic plan view of a latchbolt mechanism according to a first exemplary embodiment of the present invention, which matches a latchbolt accommodating mechanism,

FIG. 2 shows a perspective schematic view of the latchbolt mechanism according to the first exemplary embodiment of the present invention, which matches the latchbolt accommodating mechanism,

FIG. 3 shows the latchbolt mechanism according to the first exemplary embodiment of the present invention in a structural schematic view,

FIG. 4 shows the latchbolt accommodating mechanism in a structural schematic view,

FIG. 5 shows a structural schematic view of the latchbolt mechanism according to another embodiment of the present invention, which matches a latchbolt accommodating mechanism,

FIG. 6 shows a perspective schematic view of the latchbolt mechanism according to another embodiment of the present invention, which matches the latchbolt accommodating mechanism,

FIG. 7 shows a structural schematic view of the latchbolt mechanism according to another embodiment of the present invention,

FIG. 8 shows a structural schematic view of the latchbolt mechanism according to another embodiment of the present invention in a latched status,

FIG. 9 shows a structural schematic view of the latchbolt mechanism according to another embodiment of the present invention in an unlatched status,

FIG. 10 shows schematically an exploded view of a latchbolt mechanism according to another embodiment of the present invention.

### BEST MODE FOR CARRYING OUT THE INVENTION

In order that those skilled in the art can better understand the present invention, the subject matter of the present invention is further illustrated in conjunction with figures and embodiments.

### First Embodiment

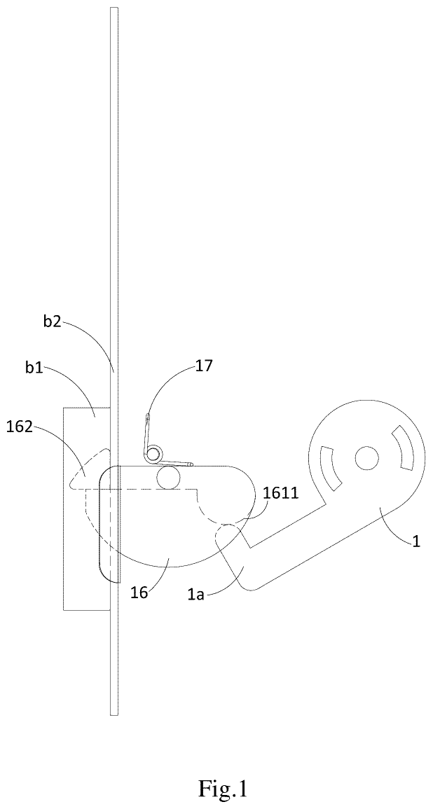

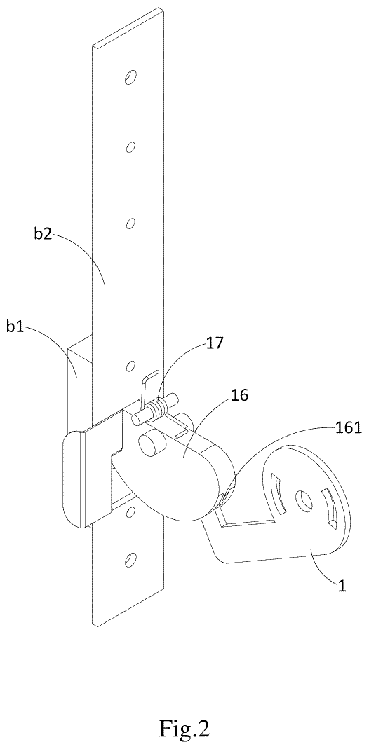

FIGS. 1 to 3 show a latchbolt mechanism, comprising a rotatable latchbolt 16 and an elastic element 17, wherein the rotatable latchbolt 16 has a plate-shaped design, in particular a semicircular plate-shaped.

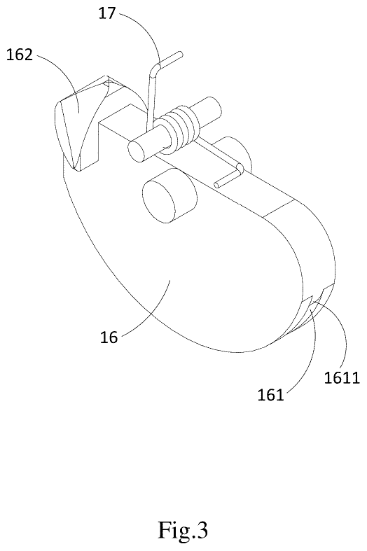

As shown in FIG. 3, a rotatable pin shaft 16 is fixedly mounted on the rotatable latchbolt 16, wherein the rotatable shaft rotates around the rotatable latchbolt 16.

As shown in FIG. 3, a stop block 162 is provided at one corner of the rotatable latchbolt 16, wherein the stop block 162 is fixed at the end portion of the rotatable latchbolt 16, wherein the boundaries between the stop block 162 and each plane of the rotatable latchbolt 16 forms a jamming block, and wherein the stop block 162 forms a protruding part. The planes of the stop block 162, which are not connected to the rotatable latchbolt 16, have an inclined design. There are three these inclined surfaces, wherein two of them are mirror-symmetrical and the other one connects these two mirror-symmetrical surfaces. The plane of the stop block 162, which is connected to the rotatable latchbolt 16, forms a front surface.

As shown in FIG. 3, a guiding groove 161 is provided in a rotating direction of the rotatable latchbolt 16. The guiding groove 161 is provided on a curved edge of the rotatable latchbolt 16, in which a stop protuberance 1611 is provided and which is perpendicular to the rotating plane of the rotatable latchbolt 16. The stop protuberance 1611 has a round cross section.

As shown in FIG. 3, the elastic element 17 holds the rotatable latchbolt 16 in an extended state. The elastic element 17 is designed as a torsion spring and bump into a linear edge of the rotatable latchbolt 16.

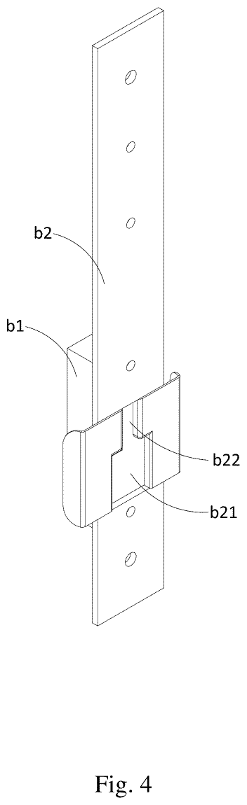

FIGS. 1, 2 and 4 show a latchbolt receiving mechanism that matches the latchbolt mechanism E, comprising a receiving chamber b1 and a cover plate b2, wherein the chamber opening of the receiving chamber b1 is covered by the cover plate b2. The cover plate b2 is provided with a first through hole b21 and a second through hole b22. The jamming block 162 is rotatably inserted into the first through hole b21 and the rotatable latchbolt is inserted rotatably into the second through hole b22. The first through hole b21 has a rectangular opening and the second through hole b22 has a rectangular opening, wherein the first through hole b21 and the second through hole b22 form an inverse convex shape.

Working process is described as follows: In a locked state, the jamming block 162 lies inside the receiving chamber b1. The torsion spring 17 exerts pressure on the rotatable latchbolt 16 in such a way that the rotatable latchbolt 16 tends to rotate clockwise. The end of the hook 1a reaches into the guiding groove 161. When the hook 1a interacts with the jamming block 162 and rotates clockwise, the rotatable latchbolt 16 rotates anticlockwise. The jamming block 162 rotates out of the through hole b21 and into the door panel and thus pushes the door panel to achieve the door-opening movement. The above working process described above also applies to a required door-closing movement.

### Second Embodiment

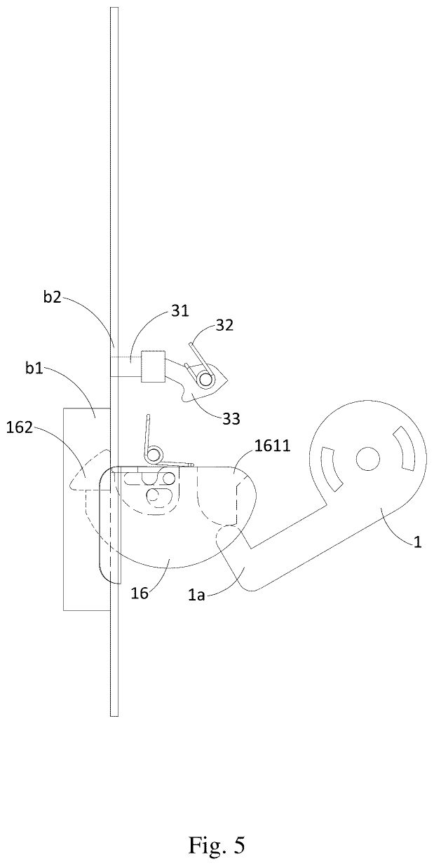

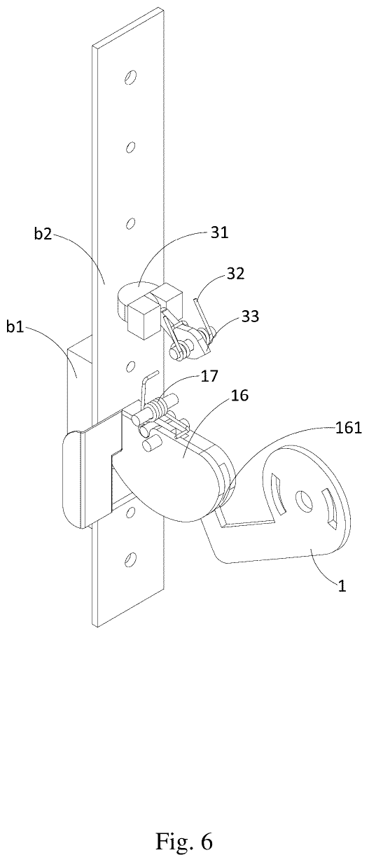

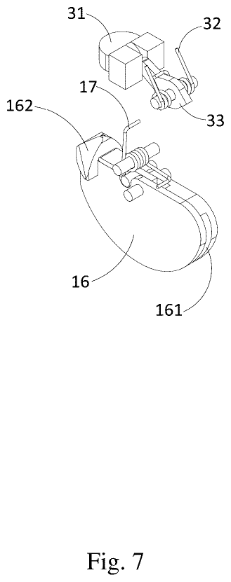

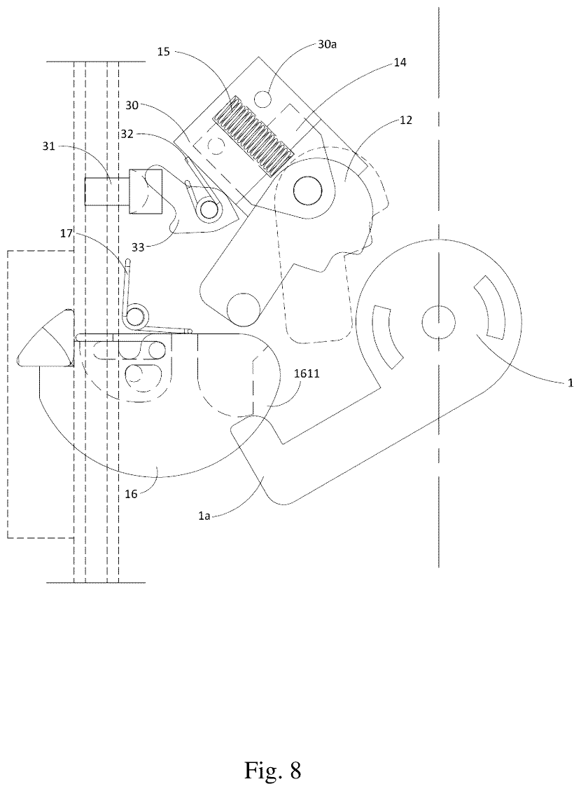

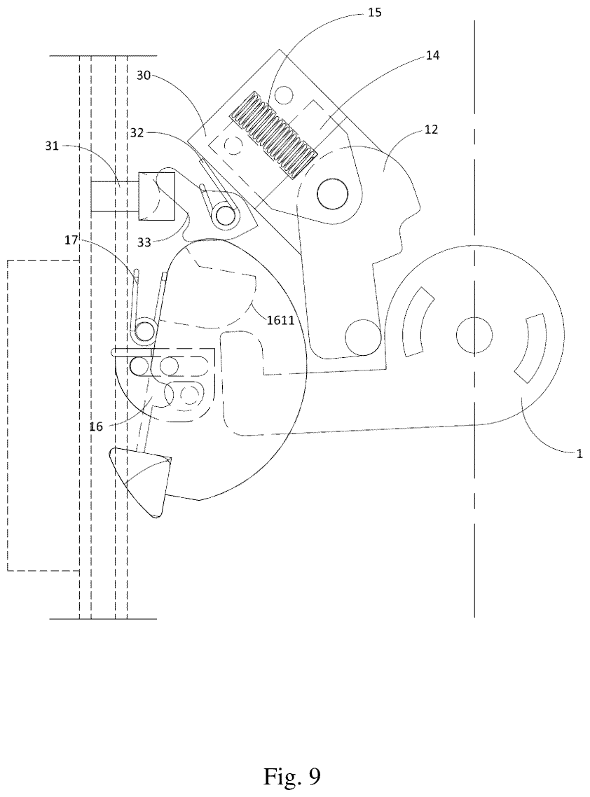

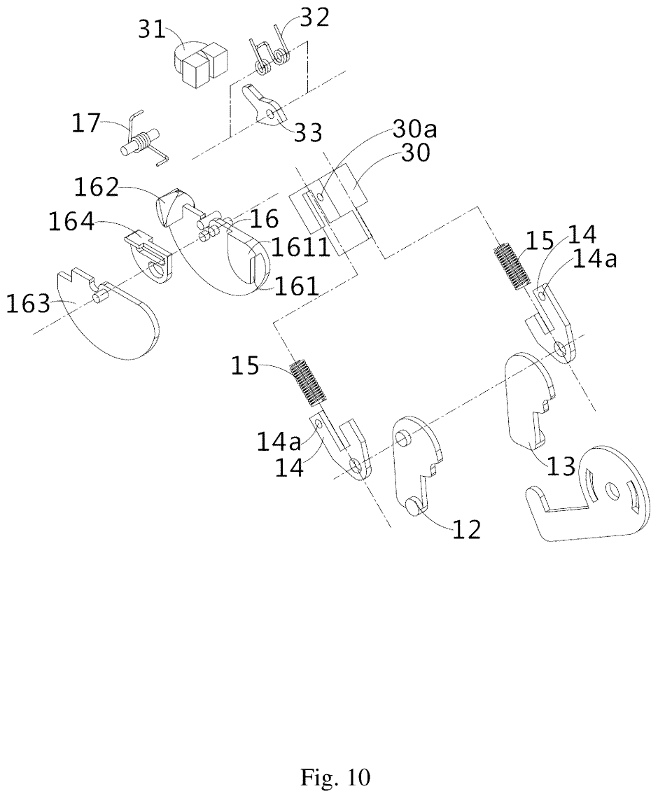

As shown in FIG. 5-10, in a further embodiment, on the basis of the aforementioned embodiment, a first latchbolt synchronizer 163 and a second latchbolt synchronizer 164 are provided on one side of the latchbolt 16 and are coaxial with a latchbolt rotating shaft to prevent the electrical locking system from being bypassed by an object such as a plastic card and to prevent the door from being forcibly opened, as shown in FIGS. 15 to 23. The second latchbolt synchronizer 164 is provided between the latchbolt 16 and the first latchbolt synchronizer 163. When the latchbolt 16 rotates along Z3 to lock the door, the second latchbolt synchronizer 164 synchronizes with the latchbolt 16, however stretches outwards with a linear movement. In the present embodiment, the jamming protuberance 1611 on the latchbolt 16 may be concave shaped compared to that in the first embodiment and has the same function as in the first embodiment. Thus, a repetition is waived here. By adding the first latchbolt synchronizer 163 and the second latchbolt synchronizer, a telescopic member 31, a double-ended tension spring 32 and a jamming hook 33. The jamming hook 33 contacts the latchbolt 16 when the latchbolt is in an unlatched state, as shown in FIG. 16. The double-ended tension spring 32 is provided inside the jamming hook 33 with one end pressing against the jamming hook 33 and the other hand contacting the mechanical locking housing 30, such that the jamming hook 33 can move when latchbolt 16 rotates. When the jamming protuberance 1611 of the bolt 16 is passed, the jamming hook 33 jams the latchbolt 16 such that the latchbolt 16 cannot rotate outwards. The telescopic member 31 can bear force and move inwards to inside the lock when closing the door. Further, the jamming hook 33 is rotated clockwise such that the jamming hook 33 leaves the area that jams the jamming protuberance to release latchbolt 16. As shown in FIGS. 15 and 16. Meanwhile, it is worth to mention that the side of the telescopic member 31, which is away from the inside of the lock, is arc-shaped, which applies for all kinds of doors. Through the arrangement of the telescopic member 31, the double-ended tension spring 32 and the jamming hook 33, the latchbolt cannot rotate outwards when the door leaves the door frame, which thus enhances the overall harmonious impression. A latchbolt is provided to avoid jamming of rope-shape objects such as strings, belts and others due to unnecessary extending out. Meanwhile, since it is not required to resist the spring force of the latchbolt when closing the door, the door closing movement is smoother. In further technical effects, such design prevents the user from accidentally locking the latchbolt when the door is opened. If the latchbolt keeps extending out when the door is opened, certain noises appear when closing a sliding door and in case a bump into the door frame is unavoidable, which itself is a damage on the door frame. This design can partially avoid the bump from the latchbolt to the door frame. Meanwhile, the bump is concentrated on telescopic member 31. The telescopic member 31 ejects automatically after bumping into a latchbolt 16, which will not affect the resilience function of the sliding door.

A latchbolt mechanism and a latchbolt accommodating mechanism according to the present invention is explained in detail above. The description of specific embodiments is only intended to help in understanding the method and core idea of the present invention. It should be noted that the skilled person in the art can make improvements and modifications without departing from the technical principles of the present invention. These improvements and modifications should also be considered as the scope of protection of the present invention.

We claims:

1. A latchbolt mechanism, characterized in that
the latchbolt mechanism comprises a rotatable latchbolt (16) and an elastic element (17),
wherein the rotatable latchbolt (16) is fixedly mounted on a rotatable pin shaft, round which the rotatable latchbolt rotates, and
wherein the elastic element (17) holds the rotatable latchbolt (16) in an extended state.

2. The latchbolt mechanism as claimed in claim 1, characterized in that
a stop block (162) is provided at one corner of the rotatable latchbolt (16),
wherein the stop block (162) is fixed at the end portion of the rotatable latchbolt (16),
wherein the boundaries between the stop block (162) and each plane of the rotatable latchbolt (16) forms a step structure, and
wherein the stop block (162) forms a protruding part.

3. The latchbolt mechanism as claimed in claim 2, characterized in that
planes of the stop block (162), which are not connected to the rotatable latchbolt (16), have an inclined or curved design, and
plane of the stop block (162), which is connected to the rotatable latchbolt (16), forms a front surface.

4. The latchbolt mechanism as claimed in claim 3, characterized in that
in the case that the planes of the stop block (162) that are not connected to the rotatable bolt (16) have an inclined design, there are at least three inclined surfaces, wherein two of them are mirror-symmetrical and the other one connects these two mirror-symmetrical surfaces.

5. The latchbolt mechanism as claimed in claim 1, characterized in that
the rotatable latchbolt (16) has a design as a plate-shaped structure.

6. The latchbolt mechanism as claimed in claim 1, characterized in that
the rotatable latchbolt (16) has a semicircular design.

7. The latchbolt mechanism as claimed in claim 1, characterized in that
a guiding groove (161) is provided in a rotating direction of the rotatable latchbolt (16), in which a stop protuberance (1611) is provided and which is perpendicular to the rotating plane of the rotatable latchbolt.

8. The latchbolt mechanism as claimed in claim 7, characterized in that
the stop protuberance (1611) has a round cross section.

9. A latchbolt accommodating mechanism, which matches the latchbolt mechanism as claimed in claim 1, characterized in that
the latchbolt accommodating mechanism comprises an accommodating chamber (b1) and a cover plate (b2), wherein a chamber opening of the accommodating chamber is covered by the cover plate, and
wherein a first through hole (b21) and a second through hole (b22) are mounted on the cover plate, wherein the stop block (162) is inserted rotatably into the first through hole (b21) and the rotatable latchbolt (16) is inserted rotatably into the second through hole (b22).

10. The latchbolt accommodating mechanism as claimed in claim 9, characterized in that
opening of the first through hole (b21) is rectangular and opening of the second through hole (b22) is rectangular, wherein the first through hole (b21) and the second through hole (b22) form an inversed convex structure.

11. The latchbolt accommodating mechanism as claimed in claim 1, characterized in that
a first latchbolt synchronizer (163) and a second latchbolt synchronizer (164) are provided on one side of the latchbolt (16) and are coaxial with a latchbolt rotating shaft,
wherein the second latchbolt synchronizer (163) is provided between the latchbolt (16) and the first latchbolt synchronizer (163).

12. The latchbolt accommodating mechanism as claimed in claim 11, characterized in that
the lock further comprises a telescopic member (31), a double-ended tension spring (32) and a jamming hook (33);
wherein the jamming hook (33) contacts the latchbolt (16) when the latchbolt (16) is in an unlatched state;
wherein the double-ended tension spring (32) is provided inside the jamming hook (33) with one end pressing against the jamming hook (33) and the other end contacting a mechanical locking housing (30) such that the jamming hook (33) can move when the latchbolt (16) rotates.
